(19) United States
(12) Patent Application Publication
(10) Pub. No.: US 2010/0083184 A1
(43) Pub. Date: Apr. 1, 2010

(54) Selective grouping and manipulation of chart components

(75) Inventors: Michael Duncan Trent, Pittsburgh, PA (US); Chaokuo Lin, Pittsburgh, PA (US); Ian Patrick McCullough, Pittsburgh, PA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Inc.

(21) Appl. No.: 12/286,717

(22) Filed: Sep. 30, 2008

(51) Int. Cl. G06F 3/048

(52) U.S. Cl. 715/853; 715/863

(57) ABSTRACT

Selective grouping and manipulation of chart components is disclosed. In some embodiments, exploding chart components comprises receiving an indication of a selection of an option to explode a subset of chart components as a single unit and exploding the subset of chart components as a single unit, wherein a relative spacing and positioning between chart components in the subset is preserved when the subset is exploded as a single unit.

### BACKGROUND OF THE INVENTION

Existing pie chart technologies allow wedges of a pie chart to be independently “exploded”, moving them away from the center of the pie chart. FIG. 1A illustrates a prior art example of exploding wedges of a pie chart. FIG. 1B illustrates the same example of FIG. 1A but with a three-dimensional pie chart. FIGS. 1C-1E illustrate a prior art example of an animation of exploding pie chart wedges. As depicted in the given example, when multiple wedges are exploded, they move separately and away from one another, which may not be the desired effect.

### BRIEF DESCRIPTION OF THE DRAWINGS

Various embodiments of the invention are disclosed in the following detailed description and the accompanying drawings.

FIG. 1A illustrates a prior art example of exploding wedges of a pie chart.

FIG. 1B illustrates the same example of FIG. 1A but with a three-dimensional pie chart.

FIGS. 1C-1E illustrate a prior art example of an animation of exploding pie chart wedges.

FIG. 2A illustrates an embodiment of exploding a subset of pie chart wedges as a single unit.

FIG. 2B illustrates the same example of FIG. 2A but with a three-dimensional pie chart.

FIGS. 2C-2E illustrate an embodiment of an animation of exploding a subset of pie chart wedges.

FIG. 3 illustrates an embodiment of exploding a subset of adjacent chart components of a donut-shaped chart as a single unit.

FIG. 4 illustrates an embodiment of a process 400 for manipulating a subset of chart components as a single unit.

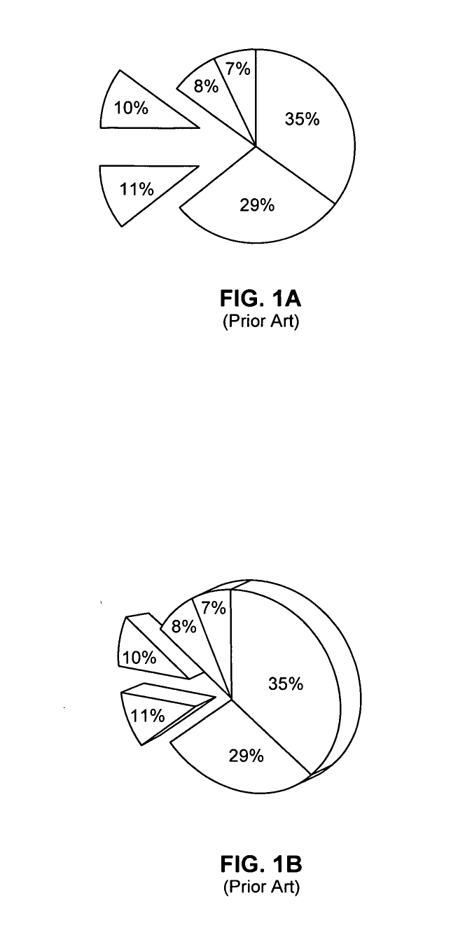

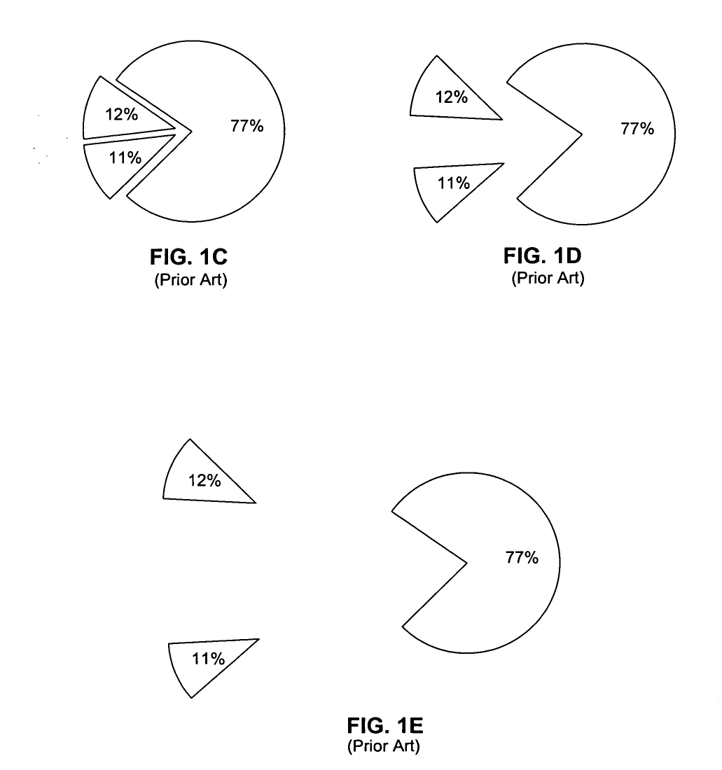

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Selective grouping and manipulation of chart components is disclosed. In various embodiments, a chart may be associated with any appropriate type of application, such as a word processing application, presentation application, spreadsheet application, desktop publishing application, web site design application, etc. In some embodiments, a chart is associated with at least standard spreadsheet functionality. The term “at least standard spreadsheet functionality” in the context of a chart includes the ability to define a chart based at least in part on the content of one or more cells and to update the chart automatically and without further human action if the content of one or more of the one or more cells is changed. Although some of the provided examples are with respect to pie charts, the techniques described herein may be similarly employed with respect to any other appropriate chart, graph, or other pictorial and/or graphical representation of a set of values that provides a pictorial and/or graphical indication of a relative magnitude of each value relative to the other values in the set.

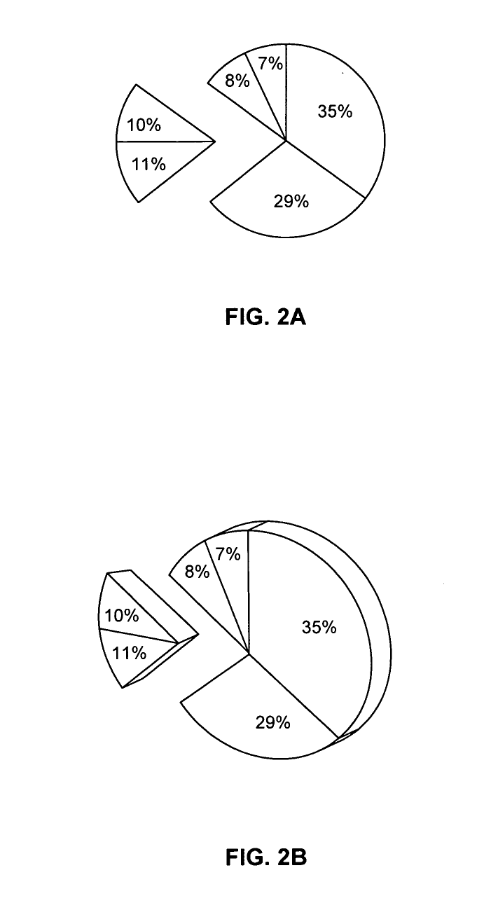

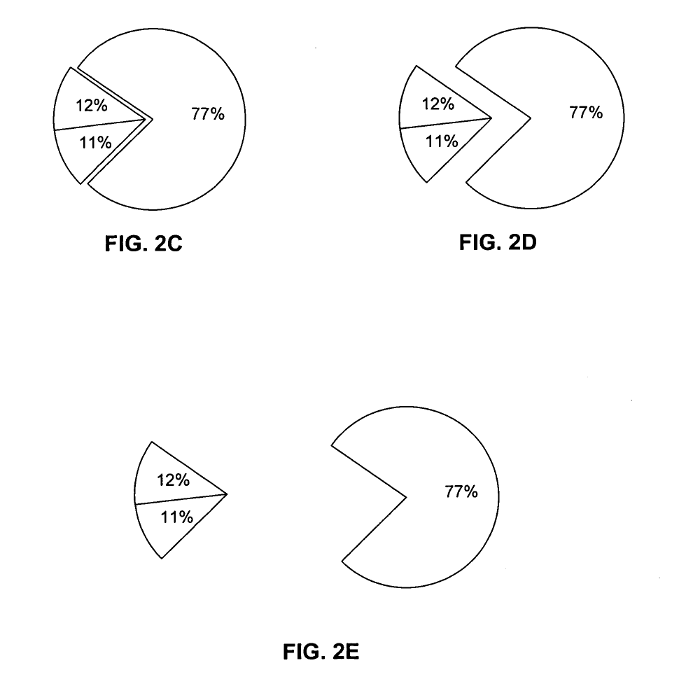

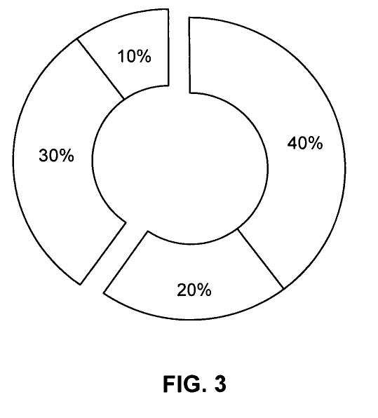

Preserving the relative spacing and positioning between chart components when they are moved in a group as a single unit is disclosed. FIG. 2A illustrates an embodiment of exploding a subset of pie chart wedges as a single unit. FIG. 2B illustrates the same example of FIG. 2A but with a three-dimensional pie chart. FIGS. 2C-2E illustrate an embodiment of an animation of exploding a subset of pie chart wedges. As depicted, the wedges in the given example stick together and move away from the center of the chart in a group as a single unit. FIG. 3 illustrates an embodiment of exploding a subset of adjacent chart components of a donut-shaped chart as a single unit. In each of the given examples, the relative spacing and positioning between chart components is preserved as they are moved together in a group as a single unit away from their original positions.

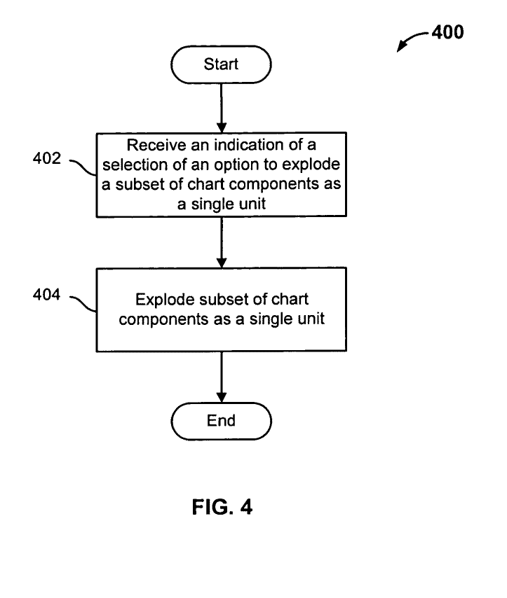

FIG. 4 illustrates an embodiment of a process 400 for manipulating a subset of chart components as a single unit. In some embodiments, a subset of chart components comprises fewer than all components of the chart. In some embodiments, the subset of chart components comprises a subset of adjacent chart components. In some such cases, each chart component in a subset of adjacent chart components shares at least one edge or boundary with another chart component in the subset. In some embodiments, process 400 is employed to explode a subset of chart components as a single unit. For example, process 400 may be employed to explode the subsets of chart components illustrated in FIGS. 2A-2E and FIG. 3. In some embodiments, the relative spacing and positioning between chart components in a subset of chart components is preserved when the subset is moved as a single unit.

Process 400 starts at 402 at which an indication of a selection of an option to explode a subset of chart components as a single unit is received. In some embodiments, the indication comprises a user interface gesture associated with exploding a subset of chart components as a single unit, such as holding down a prescribed keyboard key such as the Shift key. At 404, the subset of chart components is exploded as a single unit. In some embodiments, 404 includes receiving an indication of a user interface gesture associated with moving the subset of chart components such as drag and/or drop operations. Process 400 subsequently ends.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A computer program product for exploding chart components, the computer program product being embodied in a computer readable storage medium and comprising computer instructions for:
receiving an indication of a selection of an option to explode a subset of chart components as a single unit; and
exploding the subset of chart components as a single unit;
wherein a relative spacing and positioning between chart components in the subset is preserved when the subset is exploded as a single unit.

2. The computer program product recited in claim 1, wherein the indication comprises a user interface gesture associated with exploding a subset of chart components as a single unit.

3. The computer program product recited in claim 2, wherein the user interface gesture comprises holding down a prescribed key of a keyboard.

4. The computer program product recited in claim 1, further comprising computer instructions for receiving an indication of a user interface gesture associated with moving the subset of chart components.

5. The computer program product recited in claim 1, wherein the subset of chart components comprises a subset of adjacent chart components.

6. The computer program product recited in claim 1, wherein the subset of chart components comprises wedges of a pie chart.

7. The computer program product recited in claim 1, wherein exploding the subset of chart components as a single unit comprises moving the subset of chart components away from a center point of an associated chart.

8. The computer program product recited in claim 1, wherein the subset of chart components is associated with a chart that has at least standard spreadsheet functionality.

9. A system for exploding chart components, comprising:
a processor configured to:
receive an indication of a selection of an option to explode a subset of chart components as a single unit; and
explode the subset of chart components as a single unit; and
a memory coupled to the processor and configured to provide the processor with instructions;
wherein a relative spacing and positioning between chart components in the subset is preserved when the subset is exploded as a single unit.

10. The system recited in claim 9, wherein the indication comprises a user interface gesture associated with exploding a subset of chart components as a single unit.

11. The system recited in claim 9, wherein the subset of chart components comprises a subset of adjacent chart components.

12. The system recited in claim 9, wherein the subset of chart components comprises wedges of a pie chart.

13. The system recited in claim 9, wherein exploding the subset of chart components as a single unit comprises moving the subset of chart components away from a center point of an associated chart.

14. The system recited in claim 9, wherein the subset of chart components is associated with a chart that has at least standard spreadsheet functionality.

15. A method for exploding chart components, comprising:
receiving an indication of a selection of an option to explode a subset of chart components as a single unit; and
exploding the subset of chart components as a single unit;
wherein a relative spacing and positioning between chart components in the subset is preserved when the subset is exploded as a single unit.

16. The method recited in claim 15, wherein the indication comprises a user interface gesture associated with exploding a subset of chart components as a single unit.

17. The method recited in claim 15, wherein the subset of chart components comprises a subset of adjacent chart components.

18. The method recited in claim 15, wherein the subset of chart components comprises wedges of a pie chart.

19. The method recited in claim 15, wherein exploding the subset of chart components as a single unit comprises moving the subset of chart components away from a center point of an associated chart.

20. The method recited in claim 15, wherein the subset of chart components is associated with a chart that has at least standard spreadsheet functionality.
